(19) United States
(12) Patent Application Publication
(10) Pub. No.: US 2010/0083338 A1
(43) Pub. Date: Apr. 1, 2010

(54) REMOTE CONTROL DEVICE AND REMOTE CONTROL SYSTEM

(76) Inventor: I-Jen CHIANG, Taipei (TW)

Correspondence Address: Muncy, Geissler, Olds & Lowe, PLLC, P.O. BOX 1364, FAIRFAX, VA, 22038-1364, US

(21) Appl. No.: 12/243,320

(22) Filed: Oct. 1, 2008

(51) Int. Cl. H04N 7/16

(52) U.S. Cl. 725/139

(57) ABSTRACT

This invention provides a remote control system, comprising a local display device, a remote display device, a local set top box component coupling to the local display device for receiving and processing broadband media signals embodying a multimedia presentation from a content provider to the display device, a remote set top box component coupling to the remote display device for receiving and processing broadband media signals embodying a multimedia presentation from the content provider to the remote display device, a local mobile phone device coupling to the local set top box component via a wireless connection, and a remote mobile phone device coupling to the remote set top box component via a wireless connection, wherein a local user utilizes the local mobile phone device to communicate with a remote user who utilizes the remote mobile phone device and to capture a current motion image or still image such that the captured current motion image or still image is processed for transmission to and display on the local display device via the local STB component and for transmission to and display on said remote display device via the remote STB component.

### BACKGROUND OF THE PRESENT INVENTION

1. Field of Invention

The present invention relates to a remote control device and a remote control system, and more particularly to a remote control system having an intelligent Set-Top Box (STB) to execute multi functions support of processing viewing information as well as the remote control system using the remote control device or a chipset, which is embedded in a on-board vehicle computer, functioned as the above-mentioned Set-Top Box (STB) component to execute multi functions support of processing text-to-speech (TTS) and viewing information as well as the remote control system using the remote control device.

2. Description of Related Arts

Various systems and devices have been developed to enhance and provide users with entertainment or informational content. One such device is the television set-top box used in many households. Set-top boxes deliver content in various formats such as audio, video, both audio and video, text and data. This content is accessible to a user through an output device, such as a television, which is coupled to the set-top box.

As described in U.S. Pub. No. 2008/0098450, the prior art provides a set top box (“STB”) apparatus configurable for handling broadcast, cable television and Internet protocol television (“IPTV”) formats by multiple operators via a single flexible operating system. This prior art further relates to a dual mode display feature that enables viewing of digital content via a first display device while enabling browsing and e-commerce functionality via an associated remote device such as a tablet or like PDA-type device (also referred interchangeably as a panel remote device) which enables a user to surf the web and/or conduct e-commerce transactions via a broadband connection to the Internet, while a broadcast A/V presentation is being viewed on that user's TV display device.

In this prior art, there is depicted a display device including the intelligent Set-Top Box (STB) component. The intelligent Set-Top Box component functions as a client device to the distribution technology component (e.g., services servers) for content access. More particularly, media contents are provided by one or more media sources (content providers or producers). Embodied as examples of media sources include head-end server devices providing content, respectively, from broadcast stations via broadcast network, from a satellite receiver over a satellite communications network, and, from a cable network operator via a cable (HFC) network. Media content is additionally provided from television relay stations and Internet sites that provide continuous media data over the Internet. A media delivery system comprises one or more servers, typically operated by, a service provider, IP media provider, broadcaster or a media deliver center. The STB component further functions as a local server to the remote device such as a tablet or like PDA-type device as it transmits both a navigable web page and/or applications and/or graphics/data/textual content.

That is, in this prior art, the STB provides a software architecture that enables TCP/IP packets comprising an IPTV broadcast or presentation to be parsed such that the regular A/V television content is processed for display on the user's TV monitor or like display device, and other content such as related graphics/data/text is processed for transmission to and display on the user's remote device (tablet) simultaneous with the presentation of the transmitted A/V content on the TV monitor or like display device. In this regard, both the STB component and remote device such as a tablet or like PDA-type device is provided with wireless communications capability, e.g., Bluetooth or Wi-Fi (IEEE 802.11 specification) technology, and IrDA (Infrared) and like short range wireless transceivers. It is understood that a wireless or wired solution may also be implemented for enabling communication between the STB component and a router. Thus, in one manner, the STB component may communicate with the Internet via a wireless modem and/or router for receiving content from the servicing servers to be parsed and displayed on the main screen display device and, including content to be bundled for communication to the remote device for display thereat. The prior art also discloses that the STB system ensures that control buttons are generated for display on the Panel Remote for the interactive browsing.

Other systems and devices have been developed to enhance and provide users with the ability to communicate with one another. Mobile phones are examples of devices used in communications. A person can use a mobile phone to transmit voice, data, text messages or even audio/video clips. A mobile phone is able to transmit and receive data wirelessly.

Recently, various technologies have been developed wherein a single controller controls a desired device in an easily and intuitively understood manner. As described in U.S. Pub. No. 2007/0124372, the number of mobile phones in use is increasing quickly and there is a fast increase in the number of functionalities available in the newer mobile phones. Yet, besides being able to make phone calls, more and more mobile phones are “smart” phones, which can run a general purpose operating system such as MICROSOFT WINDOWS® Mobile or NOKIA SYMBIAN. These have a rich set of functionalities including e-mail, Internet access, document editing, audio, video, and even 3-D games. Current high-end mobile phones not only have strong computing capability similar to the personal computers of only a few years ago, but also support of various wireless technologies such as GPRS, CDMA1x, BLUETOOTH or even Wi-Fi.

Like personal computers, smart mobile phones have a display screen and execute many of the applications, such as email and games that a personal computer can execute, albeit in scaled down versions and accessed with a more limited keypad. If mobile phones and personal computers could interact with each other more fluently, then the rich functionalities of each device could enhance the other.

In this prior art, this disclosure describes how to use a mobile phone as a smart personal controller (SPC) for a computing device, thereby mutually enhancing the functionality of both devices. By adding phone-to-computer and computer-to-phone communication capability (“interaction engine”) to each device, the mobile phone becomes a remote controller for the personal computing device (i.e., the phone becomes “SPC enhanced”). But unlike dumb TV remote controllers, the SPC enhanced mobile phone provides many advanced functions for users to interact with their personal computing devices and to control their applications on the computing devices.

Additionally, this prior art also describes the exemplary dynamic user interface mapping technique. In this prior art, to control an application via the mobile phone, the user can define which user interface elements, such as mobile phone keys, will initiate each function performed by the application.

The concurrent use of a set-top box and the mobile phone can be inconvenient. For example, when a user receives a phone call on a mobile phone while watching a broadcast channel on a television through a set-top box, the user has to locate the mobile phone in the home in order to receive the call. Concurrently, the user also has to lower the volume of the television or move away from it in order to hear the other person over the phone. Finally, if the user desires to focus all of his attention on the phone call, the user will have to either pause the rendering of the recorded content or begin recording the received broadcast content. Thus, a user must operate both his mobile phone and his remote control associated with the set-top box concurrently in order to a) receive or make a call and b) not miss any of the entertainment or informational content being output by the set-top box.

It would thus be desirable to provide smart mobile phones and a TV display device with an intelligent STB which could interact with each other more fluently, then the rich functionalities of each device could enhance the other.

### SUMMARY OF THE PRESENT INVENTION

A main object of the present invention is to provide a remote control device and a remote control system that is able to control multiple applications such that the captured current motion image or still image by means of the remote control device is processed for transmission to and display on the local display device via the local STB component and for transmission to and display on said remote display device via the remote STB component.

Another object of the present invention is to provide a remote control device and a remote control system that is able to control multiple applications such that the captured current motion image or still image by means of the remote control device is processed for transmission to and display on the local display device via the chipset of an on-board vehicle computer, which is functioned as the Set-Top Box (STB) component, and for transmission to and display on said remote display device via the remote STB component or a chipset of an on-board vehicle computer.

Another object of the present invention is to provide a remote control device and a remote control system that is able to control multiple applications such that when the remote control device is a Voice Over Internet Protocol (VOIP) phone, a local user can utilize the local Voice Over Internet Protocol (VOIP) phone to communicate with a remote user without interrupting someone person watching TV programs. In other words, someone can continue to watch TV programs and another person can utilize the Voice Over Internet Protocol (VOIP) phone to make a phone call or receive a phone call at the same time without interrupting someone person watching TV programs.

Accordingly, in order to accomplish the one or some or all above objects, the present invention provides a remote control system, comprising:

a local display device;

a remote display device;

a local set top box component coupling to the local display device for receiving and processing broadband media signals embodying a multimedia presentation from a content provider to the display device;

a remote set top box component coupling to the remote display device for receiving and processing broadband media signals embodying a multimedia presentation from the content provider to the remote display device;

a local mobile phone device coupling to the local set top box component via a wireless connection; and

a remote mobile phone device coupling to the remote set top box component via a wireless connection, wherein a local user utilizes the local mobile phone device to communicate with a remote user who utilizes the remote mobile phone device and to capture a current motion image or still image such that the captured current motion image or still image is processed for transmission to and display on the local display device via the local STB component and for transmission to and display on said remote display device via the remote STB component.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

FIG. 1 shows a system operating model according to a first preferred embodiment of the present invention.

FIG. 2 shows a system operating model according to a second preferred embodiment of the present invention.

FIG. 3 shows a system operating model according to a third preferred embodiment of the present invention.

### DETAILED DESCRIPTION OF THE PREFERRED EMBODIMENTS

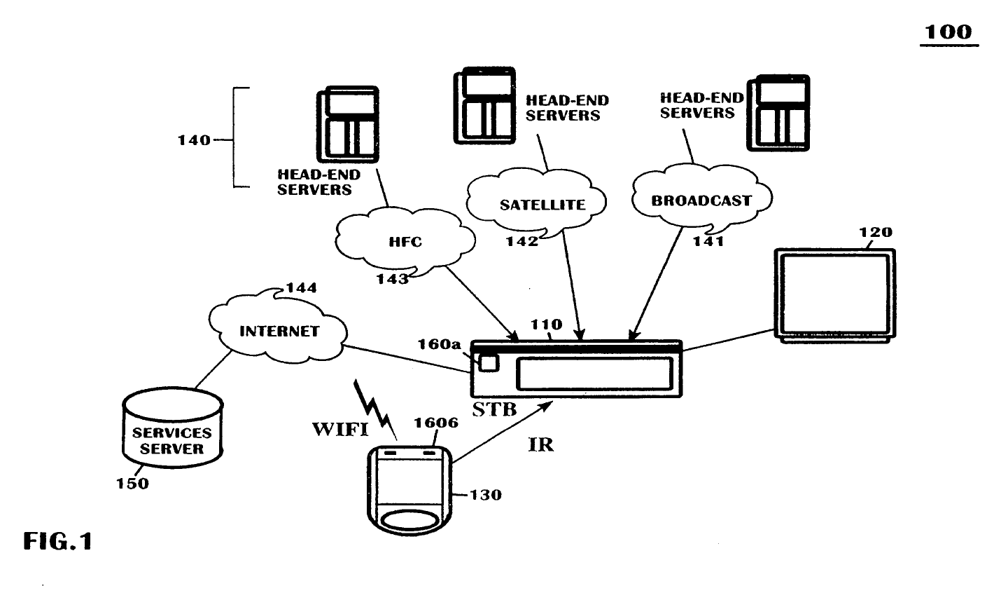

Referring to FIG. 1, a system operating model according to a first preferred embodiment of the present invention is illustrated. As shown in FIG. 1, the system operating model includes an intelligent Set-Top Box (STB) component 110, a TV monitor 120 or like display device, and a remote control device 130 such as a mobile phone. Examples of the set-top box component 110 include, but are not limited to, an Internet Protocol (IP) set-top box and a digital set-top box. Examples of the remote control device 130 include, but are not limited to, a CDMA mobile phone, a GSM mobile phone, a personal digital assistant (PDA), a third generation (3G) phone, a cordless phone and a Voice Over Internet Protocol (VOIP) phone. The intelligent Set-Top Box component 110 functions as a client device to the services servers 150 for content access. Media contents are provided by one or more media sources (content providers or producers). Media sources include head-end server devices 140 for providing content, respectively, from broadcast stations via broadcast network 141, from a satellite receiver over a satellite communications network 142, and, from a cable network operator via a cable (HFC) network 143. Media content is additionally provided from television relay stations and Internet sites that provide continuous media data over the Internet 144. A media delivery system comprises one or more servers 150, typically operated by, a service provider, IP media provider, broadcaster or a media deliver center. The STB component 110 further functions as a local server to the remote control device 130 such as a mobile phone when the STB component 110 transmits both a navigable web page and/or applications and/or graphics/data/textual content. In addition, the remote control device 130 is coupled to the Set-Top Box component 110 via a wireless connection. Examples of wireless communication media that may be used in system 100 include Bluetooth™, infrared (IR), 802.11x, 802.16x, Wireless Fidelity (WiFi), and Worldwide Interoperability for Microwave Access (WiMAX). Hence the STB component 110 receives remote control signals transmitted as either an optical signal such as an infrared signal and the like, or as an electric signal such as that used by Bluetooth, wireless LAN and the like.

According to the invention, the STB component 110 provides a software architecture that enables TCP/IP packets comprising an IPTV broadcast or presentation to be parsed such that the regular A/V television content is processed for display on the user's TV monitor 120 or like display device, and other content such as related graphics/data/text is processed for transmission to and display on the user's remote device simultaneous with the presentation of the transmitted A/V content on the TV monitor or like display device. In this regard, both the STB component 110 and remote control device 130 such as a mobile phone is provided with wireless communications capability, e.g., Bluetooth or Wi-Fi (IEEE 802.11 specification) technology, and IrDA (Infrared) and like short range wireless transceivers 160a, 160b. It is understood that the STB component 110 may communicate with the Internet for receiving content from the servicing servers 150 to be parsed and displayed on the TV monitor 120 or like display device and including content to be bundled for communication to the remote control device 130 such as a mobile phone for display thereat.

According to the invention, the STB component 110 further comprises a text-to-speech (TTS) unit and a speech-to-text unit (STT) unit (not shown in figures). The text-to-speech (TTS) unit receives textural information provided by service servers 150, the remote control device 130, and media sources including head-end server devices 140. The text-to-speech (TTS) unit processes the textural information and converts the textural information or data to voice data or information (i.e., e-mail, web pages, faxes, etc.). The text-to-speech (TTS) unit can read the voice information to the user when the user requests content information. The speech-to-text unit (STT) unit receives speech communications form the user and converts the speech communications to textual information (i.e., a text message). The textual information can be sent or routed to various communication devices or designations.

In one embodiment, when the remote control device 130 is a third generation (3 G) phone, a local user can utilize the local third generation (3G) phone to communicate with a remote user and to capture the current motion image or still image such that the captured current motion image or still image is processed for transmission to and display on the local TV monitor 120 or like display device simultaneously via the local STB component 110. Moreover, the captured current motion image or still image is processed not only for transmission to and display on the local TV monitor 120 or like display device but also for transmission to and display on the used remote third generation (3G) phone via the 3G wireless networks. Hence the remote user also can view the captured current motion image or still image on the used remote third generation (3G) phone. Of course, the remote user also can display the captured current motion image or still image on the remote TV monitor or like display device via the remote STB component. Additionally, a remote user also can utilize the remote third generation (3G) phone to capture the current motion image or still image such that the captured current motion image or still image is processed for transmission to and display on the local third generation (3G) phone via the 3G wireless networks and the local TV monitor 120 or like display device simultaneously via the STB component 110. Therefore, the third generation (3G) phones' users can utilize the system to have a video conference meeting.

In this embodiment, when the local user or the remote user enables the speech-to-text unit (STT) unit and the local user and the remote user are communicating with each other, the speech-to-text unit (STT) unit receives speech communications form the local user and the remote user and converts the speech communications to textual information (i.e., a text message). The textual information can be displayed on the mobile phone 130, the local TV monitor 120 or like display device, be processed for transmission to the used remote mobile phone, and be displayed on the used remote mobile phone and the remote TV monitor. If the local user and the remote user do not communicate with each other on line, the local user or the remote user also can enable the speech-to-text unit (STT) unit and then the speech-to-text unit (STT) unit receives speeches form the local user or the remote user and converts the speeches to textual information (i.e., a text message). The textual information can be sent or routed to various communication devices or designations.

In this embodiment, when the local user or remote user enables text-to-speech (TTS) unit, the text-to-speech (TTS) unit receives textural information provided by service servers 150, the remote control device 130, or media sources including head-end server devices 140. The text-to-speech (TTS) unit processes the textural information and converts the textural information or data to voice data or information. The text-to-speech (TTS) unit can read the voice information to the local user and the remote user when the user requests content information and the local user and the remote user are communicating with each other.

If the local user and the remote user do not communicate with each other on line, the local user or the remote user also can enable the text-to-speech (TTS) unit and then the text-to-speech (TTS) unit receives textural information provided by service servers, the remote control device, or media sources including head-end server devices. The text-to-speech (TTS) unit processes the textural information and converts the textural information or data to voice data or information. The text-to-speech (TTS) unit can read the voice information to the local user or the remote user when the local user or the remote user requests content information. The voice information also can be sent or routed to various communication devices or designations.

In another embodiment, when the remote control device 130 is a mobile phone, a local user can utilize the local mobile phone to communicate with a remote user and the content such as related graphics/data/text is processed for transmission to and display on the local TV monitor 120 or like display device simultaneously via the local STB component 110. Moreover, the content such as related graphics/data/text is processed not only for transmission to and display on the local TV monitor 120 or like display device but also for transmission to and display on the used remote mobile phone via the Internet network or the wireless networks between the local mobile phone and the remote mobile phone. In other words, the content such as related graphics/data/text displayed on the local TV monitor 120 or like display device is processed for transmission to the used remote mobile phone via the Internet network or the wireless mobile phone networks. Hence the remote user also can view the content such as related graphics/data/text on the used remote mobile phone. Of course, the remote user also can display the content such as related graphics/data/text on the remote TV monitor or like display device via the remote STB component. Additionally, a remote user also can utilize the remote mobile phone to transmit the content such as related graphics/data/text to display on the local mobile phone via the wireless networks between the local mobile phone and the remote mobile phone and the local TV monitor 120 or like display device simultaneously via the STB component 110. Therefore, the mobile phones' users can utilize the system to have a conference meeting.

In this embodiment, when the local user or the remote user enables the speech-to-text unit (STT) unit and the local user and the remote user are communicating with each other, the speech-to-text unit (STT) unit receives speech communications form the local user and the remote user and converts the speech communications to textual information (i.e., a text message). The textual information can be displayed on the mobile phone 130, the local TV monitor 120 or like display device, be processed for transmission to the used remote mobile phone, and be displayed on the used remote mobile phone and the remote TV monitor. If the local user and the remote user do not communicate with each other on line, the local user or the remote user also can enable the speech-to-text unit (STT) unit and then the speech-to-text unit (STT) unit receives speeches form the local user or the remote user and converts the speeches to textual information (i.e., a text message). The textual information can be sent or routed to various communication devices or designations.

In this embodiment, when the local user or remote user enables text-to-speech (TTS) unit, the text-to-speech (TTS) unit receives textural information provided by service servers 150, the remote control device 130, or media sources including head-end server devices 140. The text-to-speech (TTS) unit processes the textural information and converts the textural information or data to voice data or information. The text-to-speech (TTS) unit can read the voice information to the local user and the remote user when the user requests content information and the local user and the remote user are communicating with each other.

If the local user and the remote user do not communicate with each other on line, the local user or the remote user also can enable the text-to-speech (TTS) unit and then the text-to-speech (TTS) unit receives textural information provided by service servers, the remote control device, or media sources including head-end server devices. The text-to-speech (TTS) unit processes the textural information and converts the textural information or data to voice data or information. The text-to-speech (TTS) unit can read the voice information to the local user or the remote user when the local user or the remote user requests content information. The voice information also can be sent or routed to various communication devices or designations.

In addition, in another embodiment, when the remote control device 130 is a Voice Over Internet Protocol (VOIP) phone, a local user can utilize the local Voice Over Internet Protocol (VOIP) phone to communicate with a remote user without interrupting someone person watching TV programs. In other words, someone can continue to watch TV programs and another person can utilize the Voice Over Internet Protocol (VOIP) phone to make a phone call or receive a phone call at the same time without interrupting someone person watching TV programs.

In this invention, the STB component 110 can ensure that control buttons are generated for display on the remote control device 130 such as a mobile phone for the interactive browsing. Moreover, after starting an application, a user-definable technology allows the user to control the application at the user's TV monitor 120 or like display device by using the remote control device 130 such as a mobile phone. For example, using the remote control device 130, the user can proceed back and forth between slides of a graphics presentation running on the TV monitor 120, or operate controls of a multimedia player running on the TV monitor 120, using the same mobile phone user interface, such as keypad, for each application.

To control an application via the remote control device 130 such as a mobile phone, the user can define which user interface elements, such as mobile phone keys, will initiate each function performed by the application. For example, the mapping of the mobile phone keypad to TV channel message is user-definable. Thus, for example, the user may define that the “3” key on the mobile phone will correspond to the button message “3” on the general TV remote controller when a user would like to change the TV channel. Thereafter, until re-defined, when the “3” key on the mobile phone and a enter key are actuated, a “3” button message will be sent to the STB component 110, which will then proceed to change the TV channel.

In one implementation, the exemplary interaction engine supports dynamic user interface mapping by which the user is able to dynamically change or add mapping relationships between one of the mobile phone's user interfaces. “Dynamic,” as used in this context, means that a new mapping takes effect immediately after the user's change. This feature is useful when users have new applications that do not yet have corresponding user-defined key mapping layouts. The dynamic user interface mapping feature is also useful when different users have different favorite keys. For example, user Alice likes to use the “3” key for the “next channel” function, but user Bob likes the “5” key.

After the user interface mapping is defined by the user, or by a default, the mobile phone may control applications on TV monitor 120 as follows. When a user interface element, such as a key, is actuated on the TV monitor 120, the mobile phone sends a command packet to the TV monitor 120 to indicate which key was pressed. The TV monitor 120, via a user interface mapping manager, looks up the user interface mapping table based on whichever application is running, and finds the corresponding application control message. This application control message is then sent to the application, which executes the function specified.

Consequently, the remote control device 130 is able to control multiple applications. When switching from one application to another, the remote control device 130 automatically loads the corresponding key mapping table so that the user may control multiple applications conveniently.

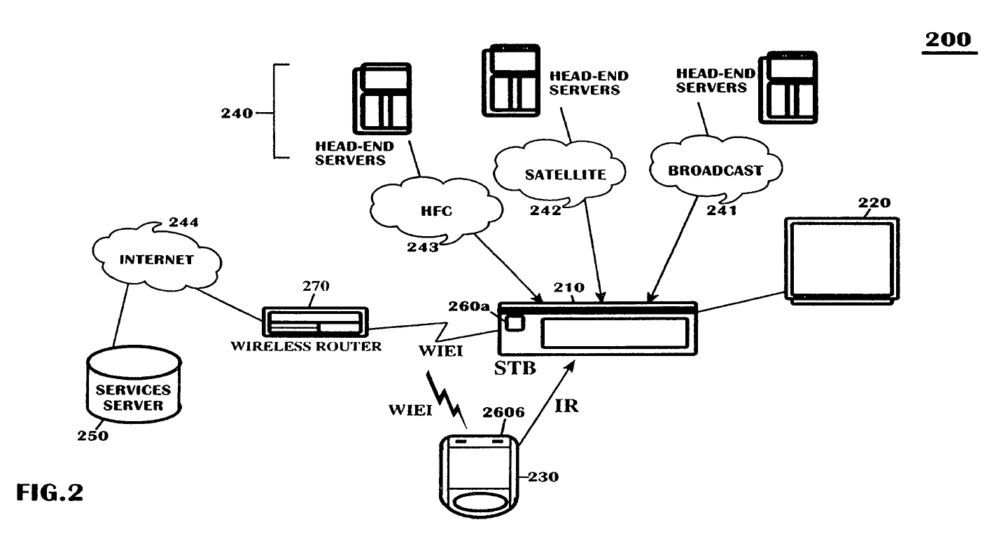

Referring to FIG. 2, a system operating model according to a second preferred embodiment of the present invention is illustrated. As shown in FIG. 2, the system operating model includes an intelligent Set-Top Box (STB) component 210, a TV monitor 220 or like display device, and a remote control device 230 such as a mobile phone. Examples of the set-top box component 210 include, but are not limited to, an Internet Protocol (IP) set-top box and a digital set-top box. Examples of the remote control device 230 include, but are not limited to, a CDMA mobile phone, a GSM mobile phone, a personal digital assistant (PDA), a third generation (3G) phone, a cordless phone and a Voice Over Internet Protocol (VOIP) phone. The intelligent Set-Top Box component 210 functions as a client device to the services servers 250 for content access. Media contents are provided by one or more media sources (content providers or producers). Media sources include head-end server devices 240 for providing content, respectively, from broadcast stations via broadcast network 241, from a satellite receiver over a satellite communications network 242, and, from a cable network operator via a cable (HFC) network 243. Media content is additionally provided from television relay stations and Internet sites that provide continuous media data over the Internet 244. A media delivery system comprises one or more servers 250, typically operated by, a service provider, IP media provider, broadcaster or a media deliver center. The STB component 210 further functions as a local server to the remote control device 130 such as a mobile phone as the STB component 210 transmits both a navigable web page and/or applications and/or graphics/data/textual content. In addition, the remote control device 230 is coupled to the Set-Top Box component 210 via a wireless connection. Examples of wireless communication media that may be used in system 100 include Bluetooth™, infrared (IR), 802.11x, 802.16x, Wireless Fidelity (WiFi), and Worldwide Interoperability for Microwave Access (WiMAX). Hence the STB component 210 receives remote control signals transmitted as either an optical signal such as an infrared signal and the like, or as an electric signal such as that used by Bluetooth, wireless LAN and the like.

According to the invention, the STB component 210 provides a software architecture that enables TCP/IP packets comprising an IPTV broadcast or presentation to be parsed such that the regular A/V television content is processed for display on the user's TV monitor 220 or like display device, and other content such as related graphics/data/text is processed for transmission to and display on the user's remote device simultaneous with the presentation of the transmitted A/V content on the TV monitor or like display device. In this regard, both the STB component 210 and remote control device 230 such as a mobile phone is provided with wireless communications capability, e.g., Bluetooth or Wi-Fi (IEEE 802.11 specification) technology, and IrDA (Infrared) and like short range wireless transceivers 260a, 260b. It is understood that a wireless or wired solution may also be implemented for enabling communication between the STB component 210 and a router 270. Thus, in one manner, the STB component 210 may communicate with the Internet via a wireless modem and/or router 270 for receiving content from the servicing servers 250 to be parsed and displayed on the main screen display device 220 and, including content to be bundled for communication to the remote device 230 for display thereat.

According to the invention, the STB component 210 further comprises a text-to-speech (TTS) unit and a speech-to-text unit (STT) unit (not shown in figures). The text-to-speech (TTS) unit receives textural information provided by service servers 250, the remote control device 230, and media sources including head-end server devices 240. The text-to-speech (TTS) unit processes the textural information and converts the textural information or data to voice data or information (i.e., e-mail, web pages, faxes, etc.). The text-to-speech (TTS) unit can read the voice information to the user when the user requests content information. The speech-to-text unit (STT) unit receives speech communications form the user and converts the speech communications to textual information (i.e., a text message). The textual information can be sent or routed to various communication devices or designations.

In one embodiment, when the remote control device 230 is a third generation (3G) phone, a local user can utilize the local third generation (3G) phone to communicate with a remote user and to capture the current motion image or still image such that the captured current motion image or still image is processed for transmission to and display on the local TV monitor 220 or like display device simultaneously via the local STB component 210. Moreover, the captured current motion image or still image is processed not only for transmission to and display on the local TV monitor 220 or like display device but also for transmission to and display on the used remote third generation (3G) phone via the 3G wireless networks. Hence the remote user also can view the captured current motion image or still image on the used remote third generation (3G) phone. Of course, the remote user also can display the captured current motion image or still image on the remote TV monitor or like display device via the remote STB component. Additionally, a remote user also can utilize the remote third generation (3G) phone to capture the current motion image or still image such that the captured current motion image or still image is processed for transmission to and display on the local third generation (3G) phone via the 3G wireless networks and the local TV monitor 220 or like display device simultaneously via the STB component 210. Therefore, the third generation (3G) phones' users can utilize the system to have a video conference meeting.

In this embodiment, when the local user or the remote user enables the speech-to-text unit (STT) unit and the local user and the remote user are communicating with each other, the speech-to-text unit (STT) unit receives speech communications form the local user and the remote user and converts the speech communications to textual information (i.e., a text message). The textual information can be displayed on the mobile phone 230, the local TV monitor 220 or like display device, be processed for transmission to the used remote mobile phone, and be displayed on the used remote mobile phone and the remote TV monitor. If the local user and the remote user do not communicate with each other on line, the local user or the remote user also can enable the speech-to-text unit (STT) unit and then the speech-to-text unit (STT) unit receives speeches form the local user or the remote user and converts the speeches to textual information (i.e., a text message). The textual information can be sent or routed to various communication devices or designations.

In this embodiment, when the local user or remote user enables text-to-speech (TTS) unit, the text-to-speech (TTS) unit receives textural information provided by service servers 250, the remote control device 230, or media sources including head-end server devices 240. The text-to-speech (TTS) unit processes the textural information and converts the textural information or data to voice data or information. The text-to-speech (TTS) unit can read the voice information to the local user and the remote user when the user requests content information and the local user and the remote user are communicating with each other.

If the local user and the remote user do not communicate with each other on line, the local user or the remote user also can enable the text-to-speech (TTS) unit and then the text-to-speech (TTS) unit receives textural information provided by service servers, the remote control device, or media sources including head-end server devices. The text-to-speech (TTS) unit processes the textural information and converts the textural information or data to voice data or information. The text-to-speech (TTS) unit can read the voice information to the local user or the remote user when the local user or the remote user requests content information. The voice information also can be sent or routed to various communication devices or designations.

In another embodiment, when the remote control device 230 is a mobile phone, a local user can utilize the local mobile phone to communicate with a remote user and the content such as related graphics/data/text is processed for transmission to and display on the local TV monitor 220 or like display device simultaneously via the local STB component 210. Moreover, the content such as related graphics/data/text is processed not only for transmission to and display on the local TV monitor 220 or like display device but also for transmission to and display on the used remote TV monitor via the Internet networks or the wireless networks between the local mobile phone and the remote mobile phone. In other words, the content such as related graphics/data/text displayed on the local TV monitor 220 or like display device is processed for transmission to the used remote mobile phone via the Internet network or the wireless mobile phone networks. Then, the content such as related graphics/data/text is processed for transmission to and display on the used remote mobile phone via the remote STB component. Hence the remote user also can view the content such as related graphics/data/text on the used remote mobile phone. Of course, the remote user also can display the content such as related graphics/data/text on the remote TV monitor or like display device via the remote STB component. Additionally, a remote user also can utilize the remote mobile phone to transmit the content such as related graphics/data/text to display on the local mobile phone via the wireless networks and the local TV monitor 220 or like display device simultaneously via the STB component 210. Therefore, the mobile phones' users can utilize the system to have a conference meeting.

In this embodiment, when the local user or the remote user enables the speech-to-text unit (STT) unit and the local user and the remote user are communicating with each other, the speech-to-text unit (STT) unit receives speech communications form the local user and the remote user and converts the speech communications to textual information (i.e., a text message). The textual information can be displayed on the mobile phone 230, the local TV monitor 220 or like display device, be processed for transmission to the used remote mobile phone, and be displayed on the used remote mobile phone and the remote TV monitor. If the local user and the remote user do not communicate with each other on line, the local user or the remote user also can enable the speech-to-text unit (STT) unit and then the speech-to-text unit (STT) unit receives speeches form the local user or the remote user and converts the speeches to textual information (i.e., a text message). The textual information can be sent or routed to various communication devices or designations.

In this embodiment, when the local user or remote user enables text-to-speech (TTS) unit, the text-to-speech (TTS) unit receives textural information provided by service servers 250, the remote control device 230, or media sources including head-end server devices 240. The text-to-speech (TTS) unit processes the textural information and converts the textural information or data to voice data or information. The text-to-speech (TTS) unit can read the voice information to the local user and the remote user when the user requests content information and the local user and the remote user are communicating with each other.

If the local user and the remote user do not communicate with each other on line, the local user or the remote user also can enable the text-to-speech (TTS) unit and then the text-to-speech (TTS) unit receives textural information provided by service servers, the remote control device, or media sources including head-end server devices. The text-to-speech (TTS) unit processes the textural information and converts the textural information or data to voice data or information. The text-to-speech (TTS) unit can read the voice information to the local user or the remote user when the local user or the remote user requests content information. The voice information also can be sent or routed to various communication devices or designations.

In addition, in another embodiment, when the remote control device 230 is a Voice Over Internet Protocol (VOIP) phone, a local user can utilize the local Voice Over Internet Protocol (VOIP) phone to communicate with a remote user without interrupting someone person watching TV programs. In other words, someone can continue to watch TV programs and another person can utilize the Voice Over Internet Protocol (VOIP) phone to make a phone call or receive a phone call at the same time without interrupting someone person watching TV programs.

In this invention, the STB component 210 can ensure that control buttons are generated for display on the remote control device 230 such as a mobile phone for the interactive browsing. Moreover, after starting an application, a user-definable technology allows the user to control the application at the user's TV monitor 220 or like display device by using the remote control device 230 such as a mobile phone. For example, using the remote control device 230, the user can proceed back and forth between slides of a graphics presentation running on the TV monitor 220, or operate controls of a multimedia player running on the TV monitor 220, using the same mobile phone user interface, such as keypad, for each application.

To control an application via the remote control device 230 such as a mobile phone, the user can define which user interface elements, such as mobile phone keys, will initiate each function performed by the application. For example, the mapping of the mobile phone keypad to TV channel message is user-definable. Thus, for example, the user may define that the “3” key on the mobile phone will correspond to the button message “3” on the general TV remote controller when a user would like to change the TV channel. Thereafter, until re-defined, when the “3” key on the mobile phone and a enter key are actuated, a “3” button message will be sent to the STB component 210, which will then proceed to change the TV channel.

In one implementation, the exemplary interaction engine supports dynamic user interface mapping by which the user is able to dynamically change or add mapping relationships between one of the mobile phone's user interfaces. “Dynamic,” as used in this context, means that a new mapping takes effect immediately after the user's change. This feature is useful when users have new applications that do not yet have corresponding user-defined key mapping layouts. The dynamic user interface mapping feature is also useful when different users have different favorite keys. For example, user Alice likes to use the “3” key for the “next channel” function, but user Bob likes the “5” key.

After the user interface mapping is defined by the user, or by a default, the mobile phone may control applications on TV monitor 220 as follows. When a user interface element, such as a key, is actuated on the TV monitor 220, the mobile phone sends a command packet to the TV monitor 220 to indicate which key was pressed. The TV monitor 220, via a user interface mapping manager, looks up the user interface mapping table based on whichever application is running, and finds the corresponding application control message. This application control message is then sent to the application, which executes the function specified.

Consequently, the remote control device 230 is able to control multiple applications. When switching from one application to another, the remote control device 130 automatically loads the corresponding key mapping table so that the user may control multiple applications conveniently.

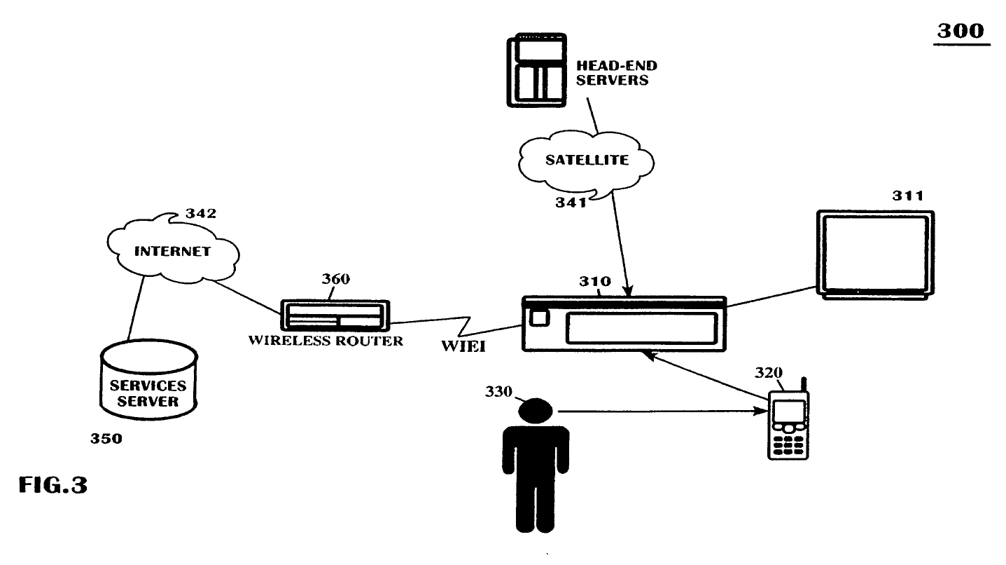

Referring to FIG. 3, a system operating model according to a third preferred embodiment of the present invention is illustrated. As shown in FIG. 3, the system operating model 300 includes a high-capability device (e.g., computer, digital television, on-board vehicle computer) 310, a low-capability (e.g. mobile phone) 320, and a user 330. There is a chipset (not shown in figures) functioned as the above-mentioned Set-Top Box (STB) component, which is embedded in the high-capability device. In the following embodiment, the example of the high-capability device is an on-board vehicle computer, but is not limited to the on-board vehicle computer. The example of the low-capability is a mobile phone, but is not limited to the mobile phone. The examples are chosen and described in order to best explain the principles of the invention and its best mode practical application, thereby to enable persons skilled in the art to understand the invention for various embodiments and with various modifications as are suited to the particular use or implementation contemplated.

The mobile phone can be used as a remote control device, but is not limited to a remote control device. The on-board vehicle computer 310 functions as a client device to the services servers 350 for content access. Media contents are provided by one or more media sources (content providers or producers). Media sources include head-end server devices 340 for providing content over a satellite communications network 341. Media content is additionally provided from television relay stations and Internet sites that provide continuous media data over the Internet 342. A media delivery system comprises one or more servers 350, typically operated by, a service provider, IP media provider, broadcaster or a media deliver center. The chipset of the on-board vehicle computer 310 further functions as a local server to the mobile phone 320 as the on-board vehicle computer 310 transmits both a navigable web page and/or applications and/or graphics/data/textual content. In addition, the mobile phone 320 is coupled to the chipset of the on-board vehicle computer 310 via a wireless connection. Examples of wireless communication media that may be used in system 300 include Bluetooth™, infrared (IR), 802.11x, 802.16x, Wireless Fidelity (WiFi), Worldwide Interoperability for Microwave Access (WiMAX), GPRS, or any other wireless standard. Hence the chipset of the on-board vehicle computer 310 receives remote control signals transmitted as either an optical signal such as an infrared signal and the like, or as an electric signal such as that used by Bluetooth, wireless LAN and the like.

According to the invention, the chipset (not shown in figures) functioned as the above-mentioned Set-Top Box (STB) component, which is embedded in on-board vehicle computer 310 provides a software architecture that enables TCP/IP packets comprising an IPTV broadcast or presentation to be parsed such that the regular A/V television content is processed for display on the vehicle monitor 311 or like display device, and other content such as related graphics/data/text is processed for transmission to and display on the user's mobile phone 320 simultaneous with the presentation of the transmitted A/V content on the TV monitor or like display device. In this regard, both the chipset of the on-board vehicle computer 310 and mobile phone 320 is provided with wireless communications capability, e.g., Bluetooth or Wi-Fi (IEEE 802.11 specification) technology, and IrDA (Infrared) and like short range wireless transceivers. It is understood that the chipset of the on-board vehicle computer 310 may communicate with the Internet via a wireless modem and/or router 360 for receiving content from the servicing servers 350 to be parsed and displayed on the vehicle monitor 311 or like display device and including content to be bundled for communication to the mobile phone 320 for display thereat.

According to the invention, the chipset of the on-board vehicle computer 310 further comprises a text-to-speech (TTS) unit and a speech-to-text unit (STT) unit (not shown in figures). The text-to-speech (TTS) unit receives textural information provided by service servers 350, the mobile phone 320, and media sources including head-end server devices 340. The text-to-speech (TTS) unit processes the textural information and converts the textural information or data to voice data or information (i.e., e-mail, web pages, faxes, etc.). The text-to-speech (TTS) unit can read the voice information to the user when the user requests content information. The speech-to-text unit (STT) unit receives speech communications form the user and converts the speech communications to textual information (i.e., a text message). The textual information can be sent or routed to various communication devices or designations.

In one embodiment, when the mobile phone 320 is a third generation (3G) phone, the local user 330 who is in a vehicle can utilize the local third generation (3G) phone to communicate with a remote user and to capture the current motion image or still image such that the captured current motion image or still image is processed for transmission to and display on the vehicle monitor 311 or like display device simultaneously via the chipset of the on-board vehicle computer 310. Moreover, the captured current motion image or still image is processed not only for transmission to and display on the vehicle monitor 311 or like display device but also for transmission to and display on the used remote third generation (3G) phone via the 3G wireless networks. Hence the remote user also can view the captured current motion image or still image on the used remote third generation (3G) phone. Of course, the remote user also can display the captured current motion image or still image on the remote monitor via the remote STB component or on the remote vehicle monitor via the chipset of the on-board vehicle computer 310. Additionally, a remote user also can utilize the remote third generation (3G) phone to capture the current motion image or still image such that the captured current motion image or still image is processed for transmission to and display on the third generation (3G) phone, which is used in the vehicle via the 3G wireless networks, and the vehicle monitor 311 or like display device simultaneously via the chipset of the on-board vehicle computer 310. Therefore, the third generation (3G) phones' users can utilize the system to have a video conference meeting even though the user is in a car.

In this embodiment, when the local user or the remote user enables the speech-to-text unit (STT) unit and the local user and the remote user are communicating with each other on line, the speech-to-text unit (STT) unit receives speech communications form the local user and the remote user and converts the speech communications to textual information (i.e., a text message). The textual information can be displayed on the mobile phone 320, the vehicle monitor 311 or like display device, be processed for transmission to the used remote mobile phone, and be displayed on the used remote mobile phone and the remote monitor. If the local user and the remote user do not communicate with each other on line, the local user or the remote user also can enable the speech-to-text unit (STT) unit and then the speech-to-text unit (STT) unit receives speeches form the local user or the remote user and converts the speeches to textual information (i.e., a text message). The textual information can be sent or routed to various communication devices or designations.

In this embodiment, when the local user or remote user enables text-to-speech (TTS) unit, the text-to-speech (TTS) unit receives textural information provided by service servers 350, the mobile phone 320, or media sources including head-end server devices 340. The text-to-speech (TTS) unit processes the textural information and converts the textural information or data to voice data or information. The text-to-speech (TTS) unit can read the voice information to the local user and the remote user when the user requests content information and the local user and the remote user are communicating with each other.

If the local user and the remote user do not communicate with each other on line, the local user or the remote user also can enable the text-to-speech (TTS) unit and then the text-to-speech (TTS) unit receives textural information provided by service servers, the remote control device, or media sources including head-end server devices. The text-to-speech (TTS) unit processes the textural information and converts the textural information or data to voice data or information. The text-to-speech (TTS) unit can read the voice information to the local user or the remote user when the local user or the remote user requests content information. The voice information also can be sent or routed to various communication devices or designations.

In another embodiment, a local user can utilize the mobile phone 320 to communicate with a remote user and the content such as related graphics/data/text is processed for transmission to and display on the vehicle monitor 311 or like display device simultaneously via the chipset of the on-board vehicle computer 310. Moreover, the content such as related graphics/data/text is processed not only for transmission to and display on the vehicle monitor 311 or like display device but also for transmission to and display on the used remote mobile phone via the wireless networks between the local mobile phone and the remote mobile phone. In other words, the content such as related graphics/data/text displayed on the vehicle TV monitor 320 or like display device is processed for transmission to the used remote mobile phone via the Internet network or the wireless mobile phone networks. Hence the remote user also can view the content such as related graphics/data/text on the used remote mobile phone. Of course, the remote user also can display the content such as related graphics/data/text on the remote monitor or like display device via the remote STB component or the chipset of the on-board vehicle computer 310. Additionally, a remote user also can utilize the remote mobile phone to transmit the content such as related graphics/data/text to display on the mobile phone which is used in a car via the wireless networks and the vehicle monitor 311 or like display device simultaneously via the chipset of the on-board vehicle computer 310. Therefore, the mobile phones' users can utilize the system to have a video conference meeting even though the user is in a car.

In this embodiment, when the local user or the remote user enables the speech-to-text unit (STT) unit and the local user and the remote user are communicating with each other, the speech-to-text unit (STT) unit receives speech communications form the local user and the remote user and converts the speech communications to textual information (i.e., a text message). The textual information can be displayed on the mobile phone 320, the vehicle monitor 311 or like display device, be processed for transmission to the used remote mobile phone, and be displayed on the used remote mobile phone and the remote monitor. If the local user and the remote user do not communicate with each other on line, the local user or the remote user also can enable the speech-to-text unit (STT) unit and then the speech-to-text unit (STT) unit receives speeches form the local user or the remote user and converts the speeches to textual information (i.e., a text message). The textual information can be sent or routed to various communication devices or designations.

In this embodiment, when the local user or remote user enables text-to-speech (TTS) unit, the text-to-speech (TTS) unit receives textural information provided by service servers 350, the mobile phone 320, or media sources including head-end server devices 340. The text-to-speech (TTS) unit processes the textural information and converts the textural information or data to voice data or information. The text-to-speech (TTS) unit can read the voice information to the local user and the remote user when the user requests content information and the local user and the remote user are communicating with each other.

If the local user and the remote user do not communicate with each other on line, the local user or the remote user also can enable the text-to-speech (TTS) unit and then the text-to-speech (TTS) unit receives textural information provided by service servers, the remote control device, or media sources including head-end server devices. The text-to-speech (TTS) unit processes the textural information and converts the textural information or data to voice data or information. The text-to-speech (TTS) unit can read the voice information to the local user or the remote user when the local user or the remote user requests content information. The voice information also can be sent or routed to various communication devices or designations.

In addition, in another embodiment, when the mobile phone 320 is a Voice Over Internet Protocol (VOIP) phone, a local user can utilize the local Voice Over Internet Protocol (VOIP) phone to communicate with a remote user without interrupting someone person watching TV programs. In other words, someone can continue to watch TV programs and another person can utilize the Voice Over Internet Protocol (VOIP) phone to make a phone call or receive a phone call at the same time without interrupting someone person watching TV programs.

In this invention, the chipset of the on-board vehicle computer 310 can ensure that control buttons are generated for display on the mobile phone 320 for the interactive browsing. Moreover, after starting an application, a user-definable technology allows the user to control the application at the user's monitor 311 or like display device by using the mobile phone 320. For example, using the mobile phone 320, the user can proceed back and forth between slides of a graphics presentation running on the monitor 311, or operate controls of a multimedia player running on the monitor 311, using the same mobile phone user interface, such as keypad, for each application.

To control an application via the mobile phone 320, the user can define which user interface elements, such as mobile phone keys, will initiate each function performed by the application. For example, the mapping of the mobile phone keypad to TV channel message is user-definable. Thus, for example, the user may define that the “3” key on the mobile phone will correspond to the button message “3” on the general TV remote controller when a user would like to change the TV channel. Thereafter, until re-defined, when the “3” key on the mobile phone and a enter key are actuated, a “3” button message will be sent to the chipset of the on-board vehicle computer 310, which will then proceed to change the TV channel.

In one implementation, the exemplary interaction engine supports dynamic user interface mapping by which the user is able to dynamically change or add mapping relationships between one of the mobile phone's user interfaces. “Dynamic,” as used in this context, means that a new mapping takes effect immediately after the user's change. This feature is useful when users have new applications that do not yet have corresponding user-defined key mapping layouts. The dynamic user interface mapping feature is also useful when different users have different favorite keys. For example, user Alice likes to use the “3” key for the “next channel” function, but user Bob likes the “5” key.

After the user interface mapping is defined by the user, or by a default, the mobile phone may control applications on monitor 311 as follows. When a user interface element, such as a key, is actuated on the monitor 311, the mobile phone sends a command packet to the monitor 311 to indicate which key was pressed. The monitor 311, via a user interface mapping manager, looks up the user interface mapping table based on whichever application is running, and finds the corresponding application control message. This application control message is then sent to the application, which executes the function specified.

Consequently, the mobile phone 320 is able to control multiple applications. When switching from one application to another, the mobile phone 320 automatically loads the corresponding key mapping table so that the user may control multiple applications conveniently.

To sum up, the present invention provides a remote control device and a remote control system that is able to control multiple applications such that the captured current motion image or still image by means of the remote control device is processed for transmission to and display on the local display device via the local STB component and for transmission to and display on said remote display device via the remote STB component. On the other hand, the present invention is to provide a remote control device and a remote control system that is able to control multiple applications such that when the remote control device is a Voice Over Internet Protocol (VOIP) phone, a local user can utilize the local Voice Over Internet Protocol (VOIP) phone to communicate with a remote user without interrupting someone person watching TV programs. In other words, someone can continue to watch TV programs and another person can utilize the Voice Over Internet Protocol (VOIP) phone to make a phone call or receive a phone call at the same time without interrupting someone person watching TV programs.

One skilled in the art will understand that the embodiment of the present invention as shown in the drawings and described above is exemplary only and not intended to be limited.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A remote control system, comprising:
a display device;
a set top box component coupling to said display device for receiving and processing broadband media signals embodying a multimedia presentation from a content provider to said display device; and
a remote control device coupling to said set top box component via a wireless connection, wherein an user utilizes said remote control device to communicate with a remote user who utilizes another remote control device and contents are processed for transmission to and display on said display device via said set top box component and for transmission to and display on said another remote control device via an Internet and said remote set top box component which is coupled to said another remote control device via wireless connection.

2. The remote control system, as recited in claim 1, wherein said display device is a TV monitor.

3. The remote control system, as recited in claim 1, wherein said set top box component is one of an Internet Protocol (IP) set-top box and a digital set-top box.

4. The remote control system, as recited in claim 2, wherein said set top box component is one of an Internet Protocol (IP) set-top box and a digital set-top box.

5. The remote control system, as recited in claim 1, wherein said remote control device is selected from the group consisting of a CDMA mobile phone, a GSM mobile phone, a personal digital assistant (PDA), a third generation (3G) phone, a cordless phone and a Voice Over Internet Protocol (VOIP) phone.

6. The remote control system, as recited in claim 4, wherein said remote control device is selected from the group consisting of a CDMA mobile phone, a GSM mobile phone, a personal digital assistant (PDA), a third generation (3G) phone, a cordless phone and a Voice Over Internet Protocol (VOIP) phone.

7. A remote control system, comprising:
a local display device;
a remote display device;
a local set top box component coupling to said local display device for receiving and processing broadband media signals embodying a multimedia presentation from a content provider to said display device;
a remote set top box component coupling to said remote display device for receiving and processing broadband media signals embodying a multimedia presentation from said content provider to said remote display device;
a local mobile phone device coupling to said local set top box component via a wireless connection; and
a remote mobile phone device coupling to said remote set top box component via a wireless connection, wherein a local user utilizes said local mobile phone device to communicate with a remote user who utilizes said remote mobile phone device and to capture a current motion image or still image such that said captured current motion image or still image is processed for transmission to and display on said local display device via said local STB component.

8. The remote control system, as recited in claim 7, wherein said display device is a TV monitor.

9. The remote control system, as recited in claim 7, wherein said set top box component is one of an Internet Protocol (IP) set-top box and a digital set-top box.

10. The remote control system, as recited in claim 8, wherein said set top box component is one of an Internet Protocol (IP) set-top box and a digital set-top box.

11. The remote control system, as recited in claim 7, wherein said local mobile phone device and said remote mobile phone device are third generation (3G) phones.

12. The remote control system, as recited in claim 10, wherein said local mobile phone device and said remote mobile phone device are third generation (3G) phones.

13. The remote control system, as recited in claim 7, wherein said captured current motion image or still image is processed for transmission to and display on said remote mobile phone device.

14. The remote control system, as recited in claim 12, wherein said captured current motion image or still image is processed for transmission to and display on said remote mobile phone device.

15. The remote control system, as recited in claim 7, wherein said captured current motion image or still image is processed for transmission to and display on said remote display device.

16. The remote control system, as recited in claim 14, wherein said captured current motion image or still image is processed for transmission to and display on said remote display device.
